(19) United States
(12) Patent Application Publication
(10) Pub. No.: US 2003/0038490 A1
(43) Pub. Date: Feb. 27, 2003

(54) Cable clamp immobilizing tool

(76) Inventor: Ronald L. Elswick, Amanda, OH (US)

Correspondence Address: Richard C. Litman, LITMAN LAW OFFICES, LTD., P.O. Box 15035, Arlington, VA, 22215, US

(21) Appl. No.: 10/195,441

(22) Filed: Jul. 16, 2002

Related U.S. Application Data
(60) Provisional application No. 60/313,461, filed on Aug. 21, 2001.

(51) Int. Cl. B25B 23/08

(52) U.S. Cl. 294/1.1; 294/15

(57) ABSTRACT

A tool for temporarily immobilizing and holding a cable clamp in an electrical box, so that a locknut can be more easily threaded onto the clamp. The tool has a front fork portion with two prongs and a rearwardly tapering space defined between the two prongs, and a back portion with a formed handle that tapers to a rounded end. The front and back portions are substantially flat and integrally formed. Two tools for varying sizes of cable clamps can be provided, preferably rivet-hinged together at their handle ends.

### CROSS-REFERENCE TO RELATED APPLICATION

This application claims the benefit of U.S. Provisional Patent Application Serial No. 60/313,461, filed Aug. 21, 2001.

### BACKGROUND OF THE INVENTION

1. Field of the Invention

The present invention relates generally to electrician's tools, and more particularly to a tool that temporarily immobilizes and holds a cable clamp in an electrical outlet box, enabling a user to thread a locknut onto the held cable clamp.

2. Description of Related Art

Electrician labor can sometimes be very tedious work. Manipulating small working electrical components and tools are common for electricians, who often develop their own specially made tools to more easily complete frequently done tasks. The related art reflects several examples of a new tool developed by a user to make a particular task easier to perform.

U.S. Pat. No. Des. 304,668 issued to Strock, describes a new ornamental design for a forked wrench.

U.S. Pat. No. 1,475,353 issued to Shapiro et al., describes a conveniently constructed device for repairing punctures in bicycle tires and other types of tires. The device is designed to be carried in the pocket of a rider so to be immediately accessible when occasion for its use arises.

U.S. Pat. No. 1,981,751 issued to Passler, describes the use of a specially shaped gauge for facilitating the setting of anchor pins of hydraulic brakes when relining brake shoes. The gauge has a pair of members, each having a shank and a head, with the head extending from one side of the shank, each head having a notch which extends at right angles to the length of the shank.

U.S. Pat. No. 4,191,235 issued to Davis, describes the use of a holding device for holding a rotatable fastener, such as a thumb screw or ring nut, against unintentional release. The device has a mounting adjacent the fastener and is movable relative to the mounting to engage and disengage with the fastener.

U.S. Pat. No. 5,321,996 issued to Wei, describes the use of a nail holder, which includes at least one nail holding plate respectively and pivotally received in a rectangular casing, each nail holding plate having two rows of nail holes disposed along two opposite long sides thereof in different diameters for holding different nails.

U.S. Pat. No. 5,943,925 issued to Huang, describes the use of a coupler pivotally coupled between a driving stem and a handle. The coupler may be selectively secured to the driving stem at any suitable angular position, and the handle may also be selectively secured to the coupler at any suitable angular position, such that the handle may be folded to engage with the driving stem for forming a compact folding structure.

U.S. Pat. No. 5,983,759 issued to Turner, describes the use of a combination tool comprising a plurality of open or box end wrenches, all pivotally connected to a common central plate or plates, which serves as an extension handle for an unfolded wrench. Stop means are also provided to lock a selected wrench in a fully extended position.

Each of the devices described in each of the above patents are useful for performing a specific function. One function not discussed is an apparatus that can be used to immobilize and hold a cable clamp steady in an electrical outlet box, enabling a user to more easily thread a locknut onto the held cable clamp. Such a device would be very useful to electricians when installing a cable connection to an electrical outlet box.

None of the above inventions and patents, taken either singly or in combination, is seen to describe the instant invention as claimed.

### SUMMARY OF THE INVENTION

The invention is a tool for temporarily immobilizing and holding a cable clamp in an electrical outlet box, enabling a user to put a locknut on the held cable clamp. The tool has a front fork portion with two prongs defining a rearwardly tapering space between the two prongs, and a back portion with a formed handle that tapers to a rounded end. The front and back portions are substantially flat and integrally formed. Two tools for varying sizes of cable clamps may be provided, preferably hinged together and their handle ends.

Accordingly, it is a principal object of the invention to save time and labor in the installation of flex or cable clamps into electrical outlet boxes by an electrician.

It is another object of the invention to make it easier for an electrician to install cable clamps in a electrical outlet box.

It is a further object of the invention to provide a cable clamp immobilizing tool made up of at least two tools, each for different sizes of cable clamps, and preferably hinged together at their handle ends.

It is another object of the invention to enable a user to use only one hand in the electrical box to install a locknut onto a cable clamp.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a cable clamp being installed in an electrical outlet box with the aid of the tool according to the present invention.

FIG. 2 is an elevation view of a cable clamp immobilizing tool, and showing two such tools, hinged together at their handle ends.

FIG. 3 is a side elevation view of a cable clamp immobilizing tool holding a cable clamp steady in an electrical outlet box.

Similar reference characters denote corresponding features consistently throughout the attached drawings.

### DETAILED DESCRIPTION OF THE PREFERRED EMBODIMENT

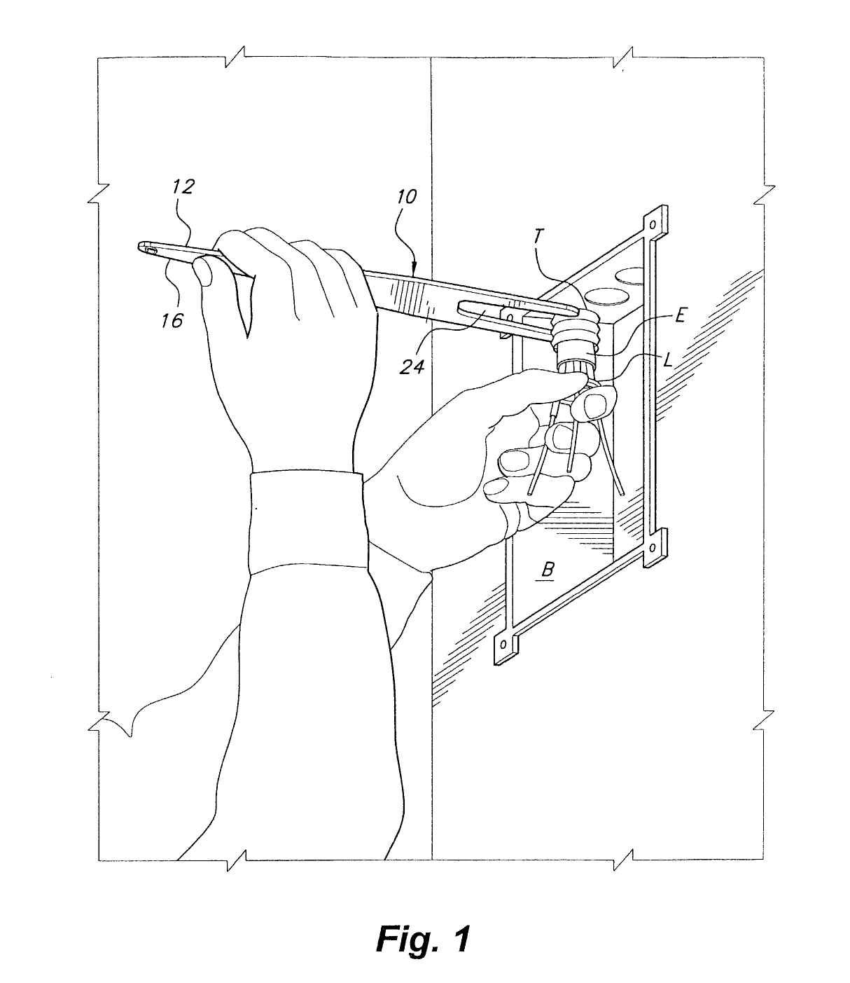

As can be appreciated from FIG. 1, the present invention is a tool 10 that holds a cable clamp C steady while in an electrical outlet box B, enabling a user to put a locknut L on the immobilized and held cable clamp C. Of course, the cable clamp C has previously been secured in place about electric cable E.

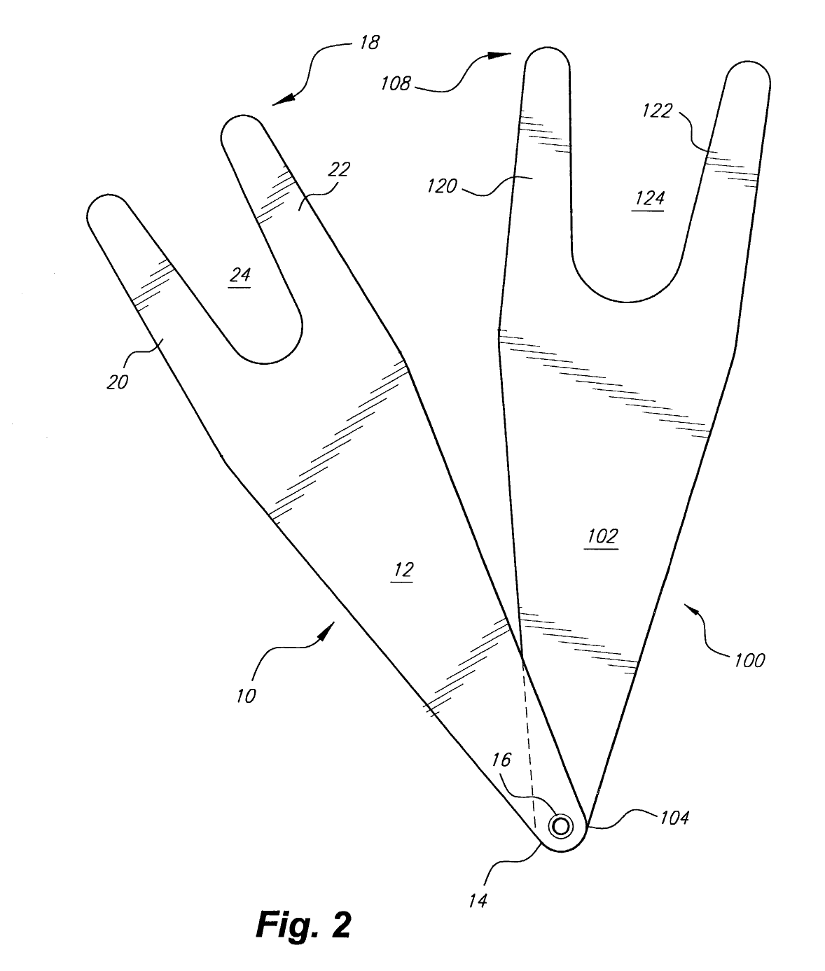

Turning now to FIG. 2, a pair of tools 10, 100 are shown, which are identical in every respect, except that they are differently sized. Each tool 10, 100 has a main handle or grip portion 12, 102, hinged together at their rear, tapered ends 14, 104 by a rivet hinge 16 as shown. The purpose of the two tools plus the rivet hinge is to have the two immediately available to accommodate differently sized cable clamps, and also to prevent the loss or misplacing of the other tool just when it is needed. Of course, the two tools could be joined by a lanyard, nut and bolt assembly, or any other joining means deemed suitable and cost effective.

Further referring to FIG. 2, each tool has a forward fork portion 18, 108, including a pair of prongs 20, 22, and 120, 122, defining respective rearwardly tapering spaces 24, 124, therebetween. In this particular instance, tool 10 has a space 24 sized to fit a ½″ cable clamp threaded end T and tool 100 has a space 124 sized to fit a ¾″ cable clamp threaded end T. The tapered openings between the prongs allow the tool to securely but only temporarily engage the threaded end of the cable clamp as the locknut is threaded onto the cable clamp threaded end.

Preferably, both tools 10, 100 are made of 1/16″ sheet metal stock or plate stock. Representative dimensions of the tools 10, 100 are as follows. The length of the ¾″ tool 100 from end to end is 5⅜″ and the length of the ½″ tool 10 is 5⅛″. The outside width at the prongs 120, 122 for the ¾″ tool 100 is 1 9/16″ and the outside width at the prongs 20, 22 for the ½″ tool 10 is 1 5/16″. Both tools are also made of galvanized metal to prevent any rust from forming on the tools.

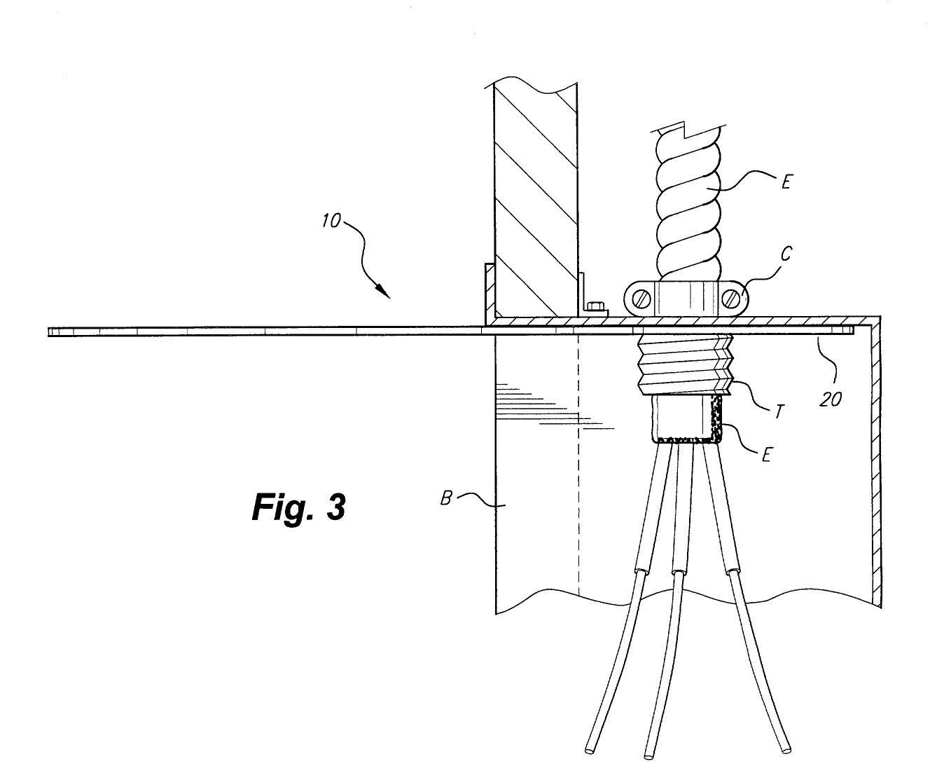

With reference to FIG. 3, it can be seen that a tool 10 is in place about the cable clamp C to temporarily immobilize and steady the clamp within the electrical outlet box B as the locknut L (FIG. 1) is threaded onto the cable clamp C to complete the assembly of the cable clamp C in the electrical outlet box B. It should be noted here that in the past, the necessary assembly just described was made tedious and difficult without the aid of the present invention. The clamp C was difficult to hold in place and immobilize while the locknut L was placed onto the threaded end of the cable clamp C. Some outlet boxes B are but two inches wide, making it most difficult to get fingers into the box to hold the threaded end of the clamp steady while the locknut is threaded into place. The job becomes even more tedious with old work, with a wall in place to slow down work even further than with new work, where the securing of the cable clamp is slow enough. With the present invention, a sure, steady hold onto the clamp C is assured while the installation is completed.

It is to be understood that the present invention is not limited to the embodiments described above, but encompasses any and all embodiments within the scope of the following claims.

I claim:

1. A tool for temporarily immobilizing and holding a cable clamp in an electrical outlet box, enabling a user to put a locknut on the held cable clamp, comprising:
a front fork portion with two prongs and a rearwardly tapering space defined between the two prongs; and
a back portion with a formed handle with a rounded end;
the front portion and the back portion being substantially flat and integrally formed;
whereby the fork portion can be placed onto the cable clamp to immobilize the clamp temporarily in the electrical box, and thus facilitate the threading of a locknut onto the cable clamp to complete the installation of the cable clamp in the electrical box.

2. The tool for temporarily immobilizing and holding a cable clamp in an electrical outlet box according to claim 1, further comprising a pair of said tools, hinged together at the respective handle ends, and having differing dimensions of tapered spaces between their respective prongs for accommodating differently sized cable clamps.

3. The tool for temporarily immobilizing and holding a cable clamp in an electrical outlet box, according to claim 1, wherein said tool is made of galvanized metal.
